(19) United States
(12) Patent Application Publication
(10) Pub. No.: US 2026/0141907 A1
(43) Pub. Date: May 21, 2026

(54) DUAL-MODE AUDIO CODING SYSTEM AND DUAL-MODE AUDIO CODING METHOD

(71) Applicant: Generalplus Technology Inc., Hsinchu City (TW)

(72) Inventors: CHIH HSIANG YANG, Hsinchu City (TW); LI SHENG LO, Hsinchu City (TW)

(21) Appl. No.: 19/391,857

(22) Filed: Nov. 17, 2025

(30) Foreign Application Priority Data
Nov. 18, 2024 (TW) 113144341

(51) Int. Cl. G10L 19/008; H04R 3/12; H04R 9/06

(52) U.S. Cl. CPC G10L 19/008; H04R 3/12; H04R 9/06; H04R 2420/07

(57) ABSTRACT

A dual-mode audio coding system and a dual-mode audio coding method are provided in the embodiments of the present invention. The system includes a signal transmission device and a signal reception device. The transmission device comprises a first control circuit and a sound circuit, where the sound circuit incorporates a sound diaphragm and an electromagnetic coil. Based on the instructions from the first control circuit, it emits audio sound waves and high-frequency sound waves while transmitting electromagnetic signals through the coil, with the frequency of the high-frequency sound waves being higher than that of the audio sound waves. The reception device consists of a second control circuit, a sound reception circuit, and an electromagnetic reception circuit, which are used to receive audio and high-frequency sound waves as well as electromagnetic signals. The first control circuit modulates communication signals into high-frequency sound waves and electromagnetic signals, while the second control circuit demodulates the received signals to reconstruct the original communication signals.

### CROSS-REFERENCE TO RELATED APPLICATIONS

This application claims priority of No. 113144341 filed in Taiwan R.O.C. on Nov. 18, 2024 under 35 USC 119, the entire content of which is hereby incorporated by reference.

### BACKGROUND OF THE INVENTION

### Field of the Invention

The present invention relates to the technology for communication encoding and code transmission, more particularly, the present invention relates to a dual-mode audio coding system and a dual-mode audio coding method.

### Description of the Related Art

Electronic devices or systems with wireless communication capabilities allow users to operate without being restricted by signal transmission wires, making wireless communication one of the most popular features. For those familiar with the technology, these electronic systems need to transmit signals wirelessly between the transmitting and receiving devices. Existing communication technologies primarily use infrared (IR) or electromagnetic waves (such as radio waves or Bluetooth) to carry communication signals. However, these methods are relatively costly, which limits their widespread use.

On the other hand, current technologies also use ultrasonic or similar techniques to achieve various functions, such as distance measurement or obstacle detection. However, these ultrasonic wireless systems require dedicated ultrasonic actuators or high-frequency oscillators to emit ultrasonic waves, which also come with a higher cost. It is worth noting that control circuits or microprocessors capable of sound playback and reception are already quite common and inexpensive. Therefore, utilizing existing sound playback and reception equipment to achieve wireless communication functionality would be a highly valuable technology.

Based on years of experience in developing audio communication products, there are two main drawbacks: one is the low data rate, and the other is the need for a crystal oscillator to improve reception accuracy. Additionally, sound is more easily affected by high-frequency or white noise.

### BRIEF SUMMARY OF THE INVENTION

The objective of a preferred embodiment of the present invention is to provide a dual-mode audio coding system and a dual-mode audio coding method, which are designed to increase data capacity, improve reception accuracy, and simultaneously enable normal sound playback functionality.

In view of this, a preferred embodiment of the present invention provides a dual-mode audio encoding system. The dual-mode audio encoding system includes a signal transmitting device and a signal receiving device. The signal transmitting device includes a first speaker circuit and a first control circuit. The first speaker circuit includes an electromagnetic coil for driving an acoustic diaphragm. The first control circuit is coupled to the first speaker circuit, for modulating a first communication signal into an electromagnetic signal, wherein the first speaker circuit vibrates the acoustic diaphragm to generate an acoustic wave according to the control of the first control circuit, and emits the electromagnetic signal through the electromagnetic coil. The signal receiving device includes an electromagnetic reception circuit and a second control circuit. The electromagnetic reception circuit is configured to receive the electromagnetic signal. The second control circuit is coupled to the electromagnetic reception circuit, for demodulating the received electromagnetic signal to obtain the first communication signal.

Another exemplary embodiment of the present invention provides a dual-mode audio encoding method, the method includes: modulating a first communication signal into an electromagnetic signal; and using an acoustic diaphragm of a first speaker circuit to emit an ordinary audio frequency while simultaneously using the electromagnetic coil of the first speaker circuit to emit the electromagnetic signal.

In the dual-mode audio encoding system and the dual-mode audio encoding method according to the preferred embodiment of the present invention, the method further includes: modulating a second communication signal into a high-frequency acoustic signal; and using the acoustic diaphragm of the first speaker circuit to emit the ordinary audio frequency while simultaneously using the acoustic diaphragm of the first speaker circuit to emit the high-frequency acoustic signal.

In the dual-mode audio encoding system and the dual-mode audio encoding method according to the preferred embodiment of the present invention, modulating the first communication signal into the electromagnetic signal comprises amplitude shift keying and self-synchronizing transmission encoding. In a preferred embodiment, the self-synchronizing transmission encoding comprises at least one of the following encodings: Pulse Position Modulation (PPM); Pulse Density Modulation (PDM); Manchester encoding; and Biphase encoding.

In the dual-mode audio encoding system and the dual-mode audio encoding method according to the preferred embodiment of the present invention, the signal receiving device further includes a second speaker circuit, including the electromagnetic reception circuit, wherein the electromagnetic reception circuit comprises an electromagnetic coil to drive the acoustic diaphragm of the second speaker circuit, wherein the acoustic diaphragm of the second speaker circuit can be served as an audio reception circuit.

In the dual-mode audio encoding system and the dual-mode audio encoding method according to the preferred embodiment of the present invention, the signal receiving device further includes an audio reception circuit, coupled to the second control circuit, for receiving the audio frequency acoustic wave and the high-frequency acoustic signal, wherein the second control circuit demodulates the received high-frequency acoustic signal to obtain the second communication signal.

In the dual-mode audio encoding system and the dual-mode audio encoding method according to the preferred embodiment of the present invention, the electromagnetic reception circuit further includes a resonant coil and a resonant capacitor. The resonant coil includes a first terminal and a second terminal, wherein the first terminal of the resonant coil is coupled to a power supply voltage, and the second terminal of the resonant coil is coupled to the second control circuit. The resonant capacitor includes a first terminal and a second terminal, wherein the first terminal of the resonant capacitor is coupled to the second terminal of the resonant coil, and the second terminal of the resonant capacitor is coupled to a common ground voltage.

In summary, the preferred embodiment of the dual-mode audio encoding system of the present invention offers several significant advantages. First, it is capable of simultaneously playing audio frequency sound waves while using high-frequency sound signals and electromagnetic signals for efficient information transmission, thereby significantly enhancing the flexibility of communication. This multi-mode transmission approach allows the system to choose the most appropriate transmission method based on different environmental needs, ensuring stable transmission of information under various conditions. Second, the design of the system offers high reliability. Since the frequency of the high-frequency sound signal is higher than that of the audio frequency sound wave, high-frequency signals are easier to identify and receive in complex noisy environments, thereby reducing the impact of interference. Moreover, the introduction of electromagnetic signals further corrects the accuracy of audio communication. Additionally, the modulation and demodulation techniques of the system can effectively reconstruct the original communication signal, ensuring accurate transmission of information. This is particularly important for applications that require high reliability and low latency, such as wireless communications, smart home devices, and more. Finally, the flexibility and scalability of the dual-mode system make it suitable for a wide range of applications and capable of meeting the modern society's demand for high-quality, low-latency communication.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

The accompanying drawings are provided to assist those skilled in the relevant technical field in further understanding the present invention, and are incorporated as part of the specification of the invention. The drawings illustrate exemplary embodiments of the present invention and are used together with the description to explain the principles of the invention.

FIG. 1 illustrates a schematic diagram depicting a dual-mode audio encoding system according to a preferred embodiment of the present invention.

FIG. 2 illustrates a schematic diagram depicting the first speaker circuit 103 according to a preferred embodiment of the present invention.

FIG. 3 illustrates a schematic diagram depicting a dual-mode audio encoding system according to a preferred embodiment of the present invention.

FIG. 4 illustrates a schematic diagram depicting the modulation of electromagnetic signals in a dual-mode audio encoding system according to a preferred embodiment of the present invention.

FIG. 5 illustrates a schematic diagram depicting the modulation of electromagnetic signals and high-frequency acoustic signals in a dual-mode audio encoding system according to a preferred embodiment of the present invention.

FIG. 6 illustrates a block diagram depicting the electromagnetic reception circuit 106 in a dual-mode audio encoding system according to a preferred embodiment of the present invention.

FIG. 7 illustrates a circuit diagram depicting the electromagnetic reception circuit 106 in a dual-mode audio encoding system according to a preferred embodiment of the present invention.

FIG. 8 illustrates an equivalent circuit diagram of the second speaker circuit 301 in a dual-mode audio encoding system according to a preferred embodiment of the present invention.

FIG. 9 illustrates a circuit diagram depicting the second speaker circuit 301 in conjunction with the electromagnetic reception circuit 106 in a dual-mode audio encoding system according to a preferred embodiment of the present invention.

FIG. 10 illustrates a flowchart depicting the signal transmission process in a dual-mode audio encoding method according to a preferred embodiment of the present invention.

FIG. 11 illustrates a flowchart depicting the signal reception process in a dual-mode audio encoding method according to a preferred embodiment of the present invention.

### DETAILED DESCRIPTION OF THE INVENTION

In the detailed description of the exemplary embodiments of the present invention, the exemplary embodiments will be illustrated in the accompanying drawings. Where possible, the same reference numerals are used in the drawings and the description to refer to the same or similar components. Furthermore, the methods of the exemplary embodiments are merely one implementation of the design concept of the present invention, and the following examples are not intended to limit the scope of the invention.

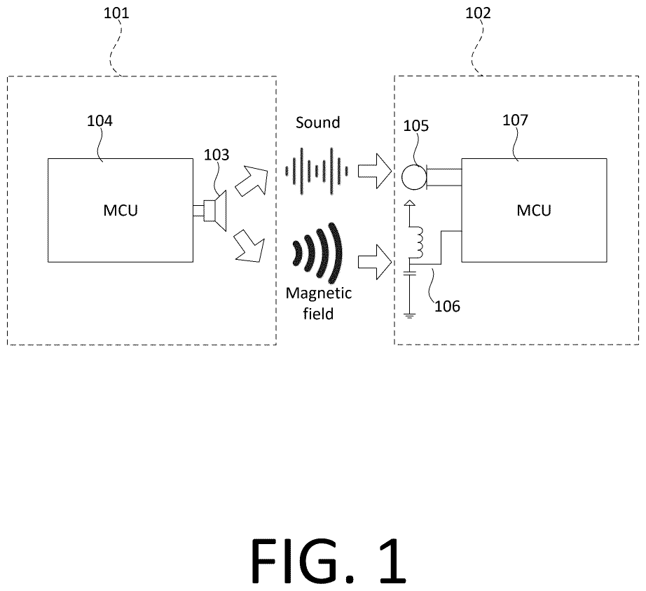

FIG. 1 illustrates a schematic diagram depicting a dual-mode audio encoding system according to a preferred embodiment of the present invention. Referring to FIG. 1, the dual-mode audio encoding system includes a signal transmitting device 101 and a signal receiving device 102. The signal transmitting device 101 includes a first speaker circuit 103 and a first control circuit 104. The signal receiving device 102 includes a sound reception circuit 105, an electromagnetic reception circuit 106, and a second control circuit 107. In this embodiment, the signal transmitting device 101 outputs, through the first speaker circuit 103, not only sound audible to the human ear but also a high-frequency sound wave signal carrying first information. In addition, the first speaker circuit 103 also outputs, through its internal electromagnetic coil, an electromagnetic signal carrying second information.

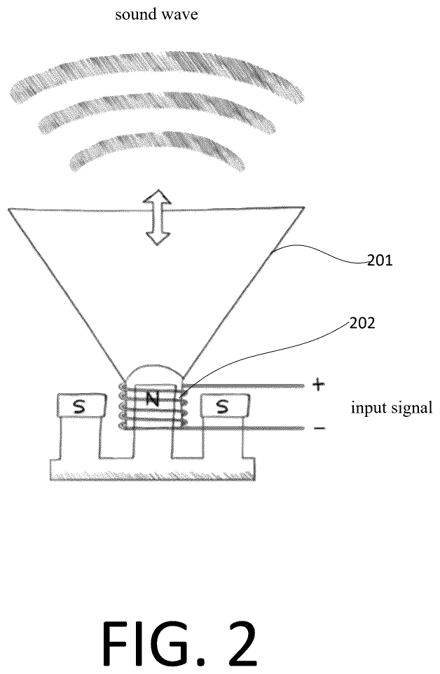

FIG. 2 illustrates a schematic diagram depicting the first speaker circuit 103 according to a preferred embodiment of the present invention. Referring to FIG. 2, the first speaker circuit 103 includes a sound diaphragm 201 and an electromagnetic coil 202. When the electromagnetic coil 202 is supplied with a sound signal source with a continuously changing current direction, an inductive magnetic field with a constantly changing direction is generated around the electromagnetic coil 202. This inductive magnetic field interacts with the magnetic field generated by a permanent magnet, alternately repelling and attracting each other, causing the electromagnetic coil 202 to move up and down. The sound diaphragm 201, which is connected to the electromagnetic coil 202, also moves up and down accordingly, thus driving the air to produce compression and rarefaction waves, and generating sound. At the same time, an alternating magnetic field with the same frequency as the sound is also generated.

Referring back to FIG. 1, the first control circuit 104 is coupled to the first speaker circuit 103, and is used to convert the first information into, for example, a serial first communication signal, and to modulate the first communication signal into a high-frequency sound wave signal. Additionally, the second information is converted into, for example, a serial second communication signal, and the second communication signal is modulated into an electromagnetic signal. At this time, assuming that the signal transmitting device 101 is playing music through the first speaker circuit 103, in this embodiment, the first control circuit 104 can, while playing the music, transmit both the high-frequency sound wave signal and the electromagnetic signal to the first speaker circuit 103. Generally, the frequency of the high-frequency sound wave signal is modulated to, for example, above 19 kHz, an ultrasonic/subsonic frequency that is difficult for the human ear to detect, and thus does not affect the music heard by the human ear.

At the same time, the frequency of the electromagnetic signal in this embodiment is transmitted through the electromagnetic coil 202 of the first speaker circuit 103. Since the high-frequency sound wave signal is essentially transmitted through the sound diaphragm 201, its frequency is limited by the maximum vibration frequency of the sound diaphragm 201. However, the electromagnetic signal is transmitted through the electromagnetic coil 202 of the first speaker circuit 103. Since the magnetic field is not affected by the sound diaphragm, it can be generated at much higher frequencies. Therefore, it can be modulated to higher frequencies, such as 40 kHz or even above 100 kHz. This will also not affect the music heard by the human ear.

The sound reception circuit 105 of the signal receiving device 102 in this embodiment, for example, is a microphone, used to receive the audio sound waves of the music and the high-frequency sound wave signal carrying the first information. And the second control circuit 107 demodulates it to obtain the first communication signal, in order to further obtain the first information sent by the signal transmitting device 101. The electromagnetic reception circuit 106 in this embodiment is implemented by a resonant coil and a resonant capacitor, and is used to receive the electromagnetic signal. Through the second control circuit 107, the electromagnetic signal is demodulated to obtain the second communication signal, in order to further obtain the second information sent by the signal transmitting device 101.

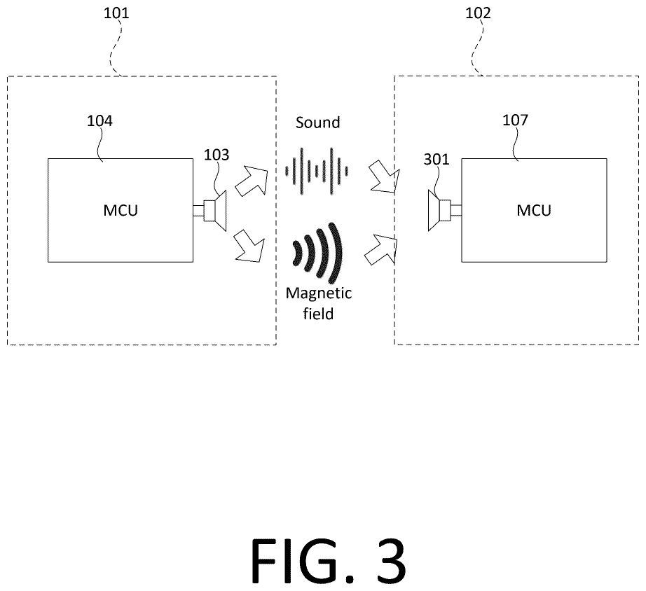

FIG. 3 illustrates a schematic diagram depicting a dual-mode audio encoding system according to a preferred embodiment of the present invention. Referring to FIG. 1 and FIG. 3, in this embodiment, both the sound reception circuit 105 and the electromagnetic reception circuit 106 are replaced by a second speaker circuit 301. The second speaker circuit 301 also includes a sound diaphragm and an electromagnetic coil. When no sound is played, the sound diaphragm can directly replace the microphone, driving the electromagnetic coil to generate an electrical signal corresponding to the received sound, which is then fed back to the second control circuit 107. Similarly, the electromagnetic coil (voice coil) of the second speaker circuit 301 can directly replace the external coil, serving as a magnetic induction component.

Although the above embodiment simultaneously uses high-frequency audio and high-frequency electromagnetic signals to transmit the first and second information, those skilled in the art will understand that, depending on the application, the signal transmitting device 101 can also transmit the magnetic field signal solely through the electromagnetic coil (voice coil) of the first speaker circuit 103, achieving the same function of simultaneously playing music and transmitting electromagnetic signals. When only using the magnetic field, the signal receiving device 102 may not require a microphone, and a low-level integrated circuit such as an 8-bit IC can be used as the second control circuit 107, which can further reduce costs. Therefore, the present invention is not limited to the above-described embodiment.

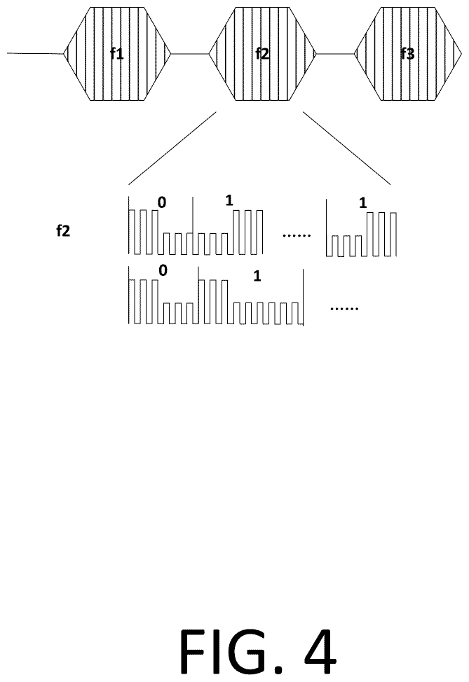

FIG. 4 illustrates a schematic diagram depicting the modulation of electromagnetic signals in a dual-mode audio encoding system according to a preferred embodiment of the present invention. Referring to FIG. 4, in this embodiment, the electromagnetic signal can adopt the same frequency as the high-frequency sound wave signal, with this audio serving as a carrier, and self-synchronizing transmission encoding (e.g., pulse position modulation (PPM), pulse density modulation (PDM), Manchester encoding, or biphase encoding) applied to the signal. Considering the energy of the audio transmission, the modulation of the magnetic field is encoded using amplitude-shift keying (ASK) as an example. In this embodiment, because the signal is transmitted at the same frequency as the audio, each transmission will feature a volume ramp-up and ramp-down design.

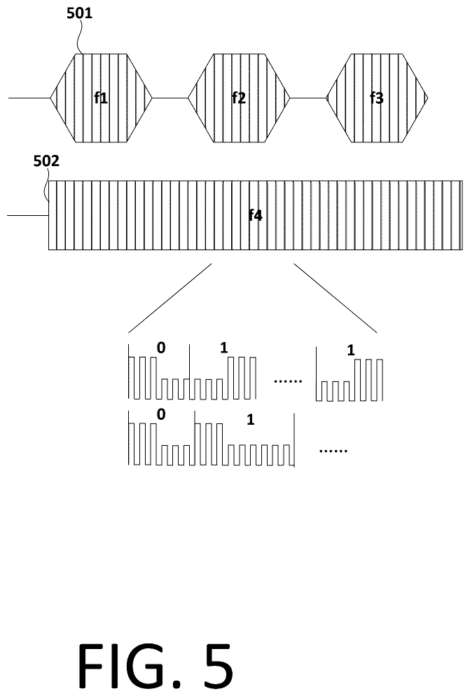

FIG. 5 illustrates a schematic diagram depicting the modulation of electromagnetic signals and high-frequency acoustic signals in a dual-mode audio encoding system according to a preferred embodiment of the present invention. Referring to FIG. 5, in this embodiment, the modulation method used for the high-frequency sound wave signal 501 can be the same as that in FIG. 4. The electromagnetic signal 502, however, operates at a different frequency from the high-frequency sound wave signal 501 used for audio communication, and similarly applies self-synchronizing transmission encoding, such as pulse position modulation (PPM), pulse density modulation (PDM), Manchester encoding, or biphase encoding. Since the magnetic field is unaffected by the speaker diaphragm, the signal can be generated at much higher frequencies, such as 40 kHz or even above 100 kHz. In this case, the magnetic field can be regarded as a separate channel, meaning there is no need to consider the volume ramp-up and ramp-down structure required for audio signals during transmission, as it can operate independently. Since the magnetic field and audio signals use different frequency bands, magnetic field communication modulation offers more options, such as amplitude-shift keying (ASK) or on-off keying (OOK).

Since magnetic field communication does not require a crystal oscillator, the signal's resonance is stronger the closer it is to the resonant frequency. Although frequency accuracy may affect the distance, even if the frequency is not precise, the signal can still be received. Therefore, this embodiment can use the time information from magnetic field communication to correct the audio communication, thereby synchronizing and improving the accuracy of audio communication reception.

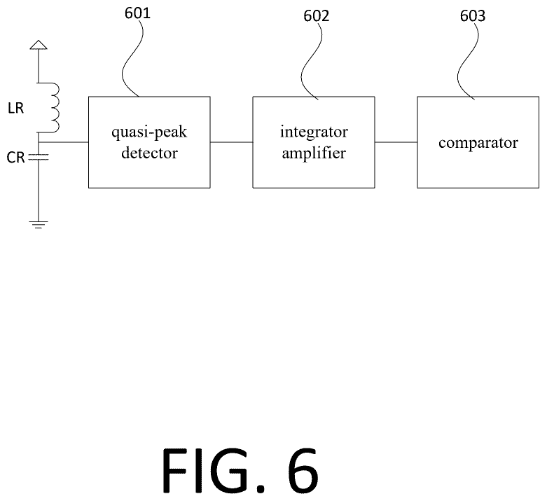

FIG. 6 illustrates a block diagram depicting the electromagnetic reception circuit 106 in a dual-mode audio encoding system according to a preferred embodiment of the present invention. Referring to FIG. 6, this electromagnetic reception circuit 106 includes a resonant coil LR, a resonant capacitor CR, a quasi-peak detector 601, an integrator amplifier 602, and a comparator 603. The quasi-peak detector 601 is used to extract the envelope from the signal received by the resonant coil LR and the resonant capacitor CR. The integrator amplifier 602 amplifies and filters the noise from the envelope, while the comparator 603 compares the signal to obtain the encoded signal after self-synchronizing transmission encoding. The encoded signal is then decoded by the second control circuit 107.

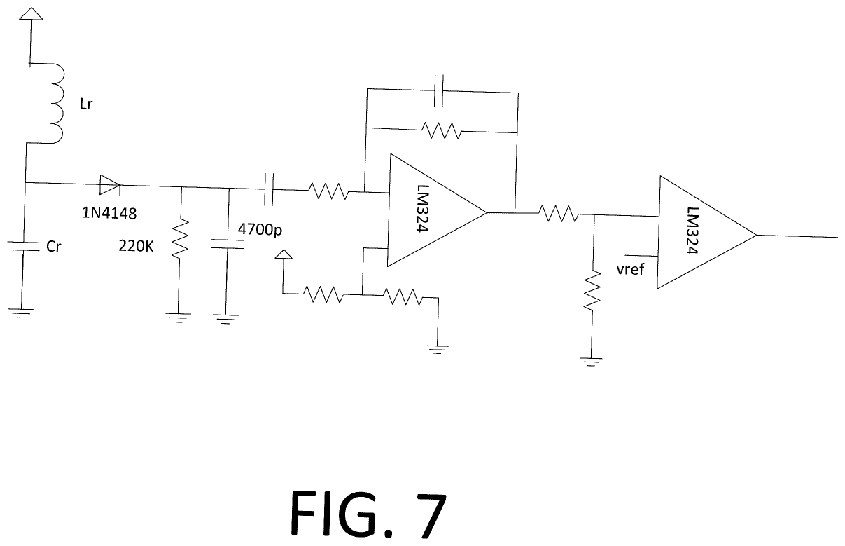

FIG. 7 illustrates a circuit diagram depicting the electromagnetic reception circuit 106 in a dual-mode audio encoding system according to a preferred embodiment of the present invention. Referring to FIG. 7, in this embodiment, the quasi-peak detector 601 is implemented using a 1N4148 diode, a 220K ohm resistor, and a 4700 pF capacitor. The integrator amplifier 602 and comparator 603 are implemented using two amplifiers from the LM324 integrated circuit, which contains four amplifiers, along with external resistors and capacitors.

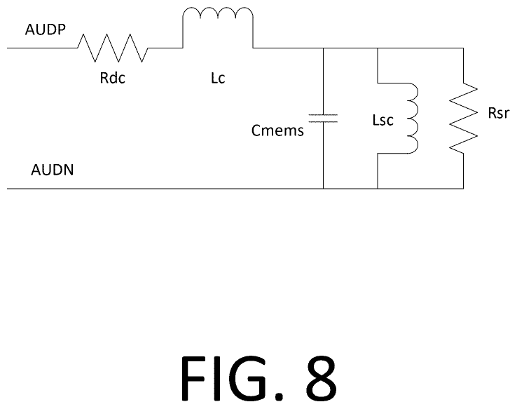

FIG. 8 illustrates an equivalent circuit diagram of the second speaker circuit 301 in a dual-mode audio encoding system according to a preferred embodiment of the present invention. Referring to FIG. 8, this equivalent circuit includes a coil resistance Rdc, a coil inductance Lc, a moving mass capacitance Cmems, a inductance of suspension compliance Lsc, and a suspension resistance Rsr. Generally, in a static reception state, the electromagnetic coil (voice coil) of the speaker circuit is not moving. Therefore, the moving mass capacitance Cmems, inductance of suspension compliance Lsc, and suspension resistance Rsr can be neglected. In other words, the equivalent circuit of the second speaker circuit 301 can be regarded as consisting of the coil resistance Rdc and coil inductance Lc.

Additionally, the specifications of a typical speaker circuit will include the inductance value of the electromagnetic coil Lc at certain frequencies. For example, the low-distortion woofer of the 12S330 model has a coil inductance of 700 pH at 1 kHz and 430 μH at 10 kHz. Assuming the electromagnetic signal operates at the lower frequency of 10 kHz, the resonant capacitor can be calculated to be approximately 0.59 μF. Therefore, both the signal transmitting device 101 and the signal receiving device 102 can actually use the same components. This means that the two devices can communicate with each other, achieving mutual encoding and decoding.

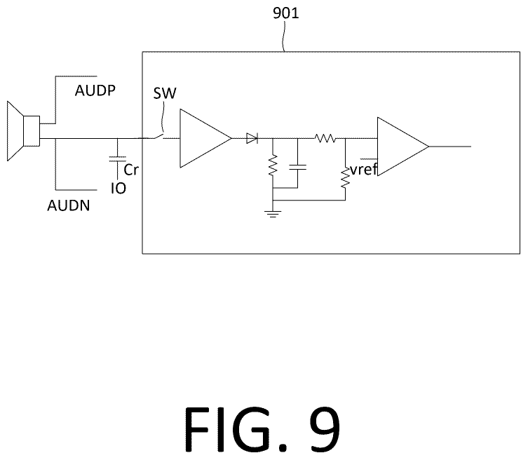

FIG. 9 illustrates a circuit diagram depicting the second speaker circuit 301 in conjunction with the electromagnetic reception circuit 106 in a dual-mode audio encoding system according to a preferred embodiment of the present invention. Referring to FIG. 9, in this embodiment, the first input terminal AUDP and the second input terminal AUDN of the second speaker circuit 301 are used to input regular audio (music). The second input terminal AUDN of the second speaker circuit 301 is additionally coupled to a terminal of the resonant capacitor Cr, where the other terminal of the resonant capacitor Cr is coupled to one of the input/output pins (IO) of the control circuit. When receiving the electromagnetic signal is performed, the input/output pin IO is set to a common voltage, and the second input terminal AUDN of the second speaker circuit 301 is set to high impedance. This allows the inductance Lc of the electromagnetic coil (voice coil) of the second speaker circuit 301 and the resonant capacitor Cr to resonate according to the received signal such that the signal can be received. At the same time, switch SW is in the conduction state, allowing the received signal to be demodulated and decoded by the demodulation circuit 901. During sound playback, the switch SW is in the cut-off state, and the input/output pin IO is set to high impedance.

Table 1 below shows the packet format of the electromagnetic signal used in the magnetic field communication of the dual-mode audio encoding system in a preferred embodiment of the present invention. Referring to Table 1, in this embodiment, the header of the electromagnetic signal packet includes 9 bits of logic 1, an 8-bit identification code ID (D00-D13), 32 bits of data (D20-D93), a 4-bit vertical check code (PC0-PC3), and a 10-bit horizontal check code (P0-P9, S0).

TABLE 1

| | | | | | | | | | |
|---|---|---|---|---|---|---|---|---|---|
| 1 | 1 | 1 | 1 | 1 | 1 | 1 | 1 | 1 | 9 header bits |

| 8 version bits or | D00 | D01 | D02 | D03 | P0 | |
|---|---|---|---|---|---|---|
| customer ID | D10 | D11 | D12 | D13 | P1 | |
| | D20 | D21 | D22 | D23 | P2 | |
| 32 data bits | D30 | D31 | D32 | D33 | P3 | |
| | D40 | D41 | D42 | D43 | P4 | |
| | D50 | D51 | D52 | D53 | P5 | |
| | D60 | D61 | D62 | D63 | P6 | |
| | D70 | D71 | D72 | D73 | P7 | |
| | D80 | D81 | D82 | D83 | P8 | |
| | D90 | D91 | D92 | D93 | P9 | 10 line parity |
| | PC0 | PC1 | PC2 | PC3 | S0 | bits |

4 column parity bits

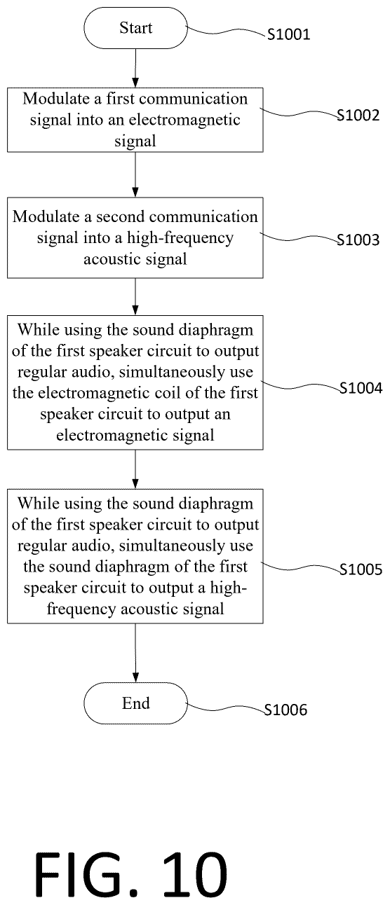

FIG. 10 illustrates a flowchart depicting the signal transmission process in a dual-mode audio encoding method according to a preferred embodiment of the present invention. Referring to FIG. 10, the signal transmission process in a dual-mode audio encoding method includes the following steps:

Step S1001: Start.

Step S1002: Modulate a first communication signal into an electromagnetic signal.

Step S1003: Modulate a second communication signal into a high-frequency acoustic signal.

Step S1004: While using the sound diaphragm of the first speaker circuit to output regular audio, simultaneously use the electromagnetic coil of the first speaker circuit to output an electromagnetic signal. For example, an electromagnetic signal above 40 kHz is emitted through the speaker's coil.

Step S1005: While using the sound diaphragm of the first speaker circuit to output regular audio, simultaneously use the sound diaphragm of the first speaker circuit to output a high-frequency acoustic signal. For example, an ultrasonic or subsonic signal, which is difficult for the human ear to detect, is emitted through the speaker's diaphragm.

Step S1006: End.

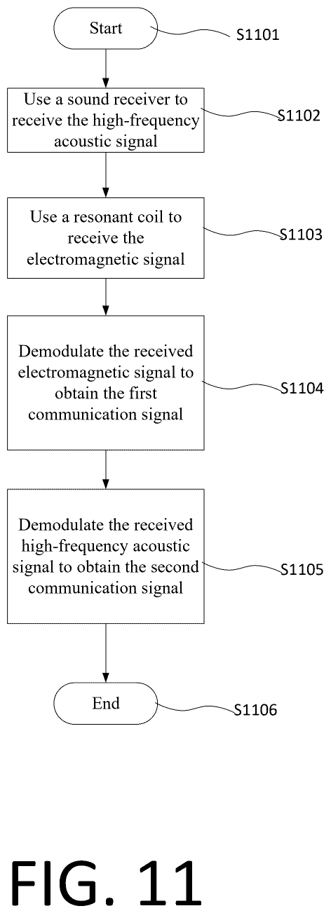

FIG. 11 illustrates a flowchart depicting the signal reception process in a dual-mode audio encoding method according to a preferred embodiment of the present invention. Referring to FIG. 11, the signal reception method in the dual-mode audio encoding method includes the following steps:

Step S1101: Start.

Step S1102: Use a sound receiver to receive the high-frequency acoustic signal.

Step S1103: Use a resonant coil to receive the electromagnetic signal. In the above embodiment, the sound receiver and resonant coil can be implemented using the sound diaphragm and electromagnetic coil of the second speaker circuit, allowing the signal receiving end to use the same device as the signal transmitting end.

Step S1104: Demodulate the received electromagnetic signal to obtain the first communication signal.

Step S1105: Demodulate the received high-frequency acoustic signal to obtain the second communication signal.

Step S1106: End.

In summary, the preferred embodiment of the dual-mode audio encoding system of the present invention offers several significant advantages. First, it is capable of simultaneously playing audio frequency sound waves while using high-frequency sound signals and electromagnetic signals for efficient information transmission, thereby significantly enhancing the flexibility of communication. This multi-mode transmission approach allows the system to choose the most appropriate transmission method based on different environmental needs, ensuring stable transmission of information under various conditions.

Second, the design of the system offers high reliability. Since the frequency of the high-frequency sound signal is higher than that of the audio frequency sound wave, high-frequency signals are easier to identify and receive in complex noisy environments, thereby reducing the impact of interference.

Moreover, the introduction of electromagnetic signals further corrects the accuracy of audio communication. Additionally, the modulation and demodulation techniques of the system can effectively reconstruct the original communication signal, ensuring accurate transmission of information. This is particularly important for applications that require high reliability and low latency, such as wireless communications, smart home devices, and more. Finally, the flexibility and scalability of the dual-mode system make it suitable for a wide range of applications and capable of meeting the modern society's demand for high-quality, low-latency communication.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A dual-mode audio encoding system, comprising:
a signal transmitting device, comprising:
a first speaker circuit, wherein the first speaker circuit includes an electromagnetic coil for driving an acoustic diaphragm; and
a first control circuit, coupled to the first speaker circuit, for modulating a first communication signal into an electromagnetic signal, wherein the first speaker circuit vibrates the acoustic diaphragm to generate an acoustic wave according to the control of the first control circuit, and emits the electromagnetic signal through the electromagnetic coil;
a signal receiving device, comprising:
an electromagnetic reception circuit, configured to receive the electromagnetic signal; and
a second control circuit, coupled to the electromagnetic reception circuit, for demodulating the received electromagnetic signal to obtain the first communication signal.

2. The dual-mode audio encoding system according to claim 1, wherein modulating the first communication signal into the electromagnetic signal comprises amplitude shift keying and self-synchronizing transmission encoding.

3. The dual-mode audio encoding system according to claim 2, wherein the self-synchronizing transmission encoding comprises at least one of the following encodings:
Pulse Position Modulation (PPM);
Pulse Density Modulation (PDM);
Manchester encoding; and
Biphase encoding.

4. The dual-mode audio encoding system according to claim 1, wherein the signal receiving device further comprises:
a second speaker circuit, comprising the electromagnetic reception circuit,
wherein the electromagnetic reception circuit comprises an electromagnetic coil to drive the acoustic diaphragm of the second speaker circuit.

5. The dual-mode audio encoding system according to claim 4, wherein the first control circuit is further configured to modulate a second communication signal into a high-frequency acoustic signal, where the frequency of the high-frequency acoustic signal is higher than that of the audio frequency acoustic signal, and the high-frequency acoustic signal is output through the acoustic diaphragm of the first speaker circuit,
wherein the acoustic diaphragm of the second speaker circuit is served as an audio reception circuit to receive the audio frequency acoustic wave and the high-frequency acoustic signal,
wherein the second control circuit demodulates the received high-frequency acoustic signal to obtain the second communication signal.

6. The dual-mode audio encoding system according to claim 1, wherein the first control circuit is further configured to modulate a second communication signal into a high-frequency acoustic signal, where the frequency of the high-frequency acoustic signal is higher than that of the audio frequency acoustic signal, and the high-frequency acoustic signal is output through the acoustic diaphragm of the first speaker circuit,
wherein the signal receiving device further comprises:
an audio reception circuit, coupled to the second control circuit, for receiving the audio frequency acoustic wave and the high-frequency acoustic signal,
wherein the second control circuit demodulates the received high-frequency acoustic signal to obtain the second communication signal.

7. The dual-mode audio encoding system according to claim 1, wherein the electromagnetic reception circuit further comprises:
a resonant coil, comprising a first terminal and a second terminal, wherein the first terminal of the resonant coil is coupled to a power supply voltage, and the second terminal of the resonant coil is coupled to the second control circuit; and
a resonant capacitor, comprising a first terminal and a second terminal, wherein the first terminal of the resonant capacitor is coupled to the second terminal of the resonant coil, and the second terminal of the resonant capacitor is coupled to a common ground voltage.

8. The dual-mode audio encoding system according to claim 1, wherein the electromagnetic reception circuit further comprises:
an envelope detection circuit, coupled between the second terminal of the resonant coil and the second control circuit.

9. The dual-mode audio encoding system according to claim 8, wherein the envelope detection circuit comprises:
a quasi-peak detector, comprising an input and an output, wherein the input of the quasi-peak detector is coupled to the second terminal of the resonant coil;
an integrator amplifier, comprising an input and an output, wherein the input of the integrator amplifier is coupled to the output of the quasi-peak detector; and
a comparator, comprising a first input, a second input, and an output, wherein the first input of the comparator is coupled to the output of the integrator amplifier, the second input of the comparator is coupled to a reference voltage, and the output of the comparator is coupled to the second control circuit.

10. A dual-mode audio encoding device, comprising:
a first control circuit; and
a first speaker circuit, coupled to the first control circuit, wherein the first speaker circuit comprises an electromagnetic coil for driving an acoustic diaphragm, and wherein the first speaker circuit vibrates the acoustic diaphragm to emit an audio frequency sound wave and emits an electromagnetic signal through the electromagnetic coil under the control of the first control circuit;
wherein the first control circuit modulates a first communication signal into the electromagnetic signal.

11. The dual-mode audio encoding device according to claim 10, wherein modulating the first communication signal into the electromagnetic signal comprises amplitude shift keying and self-synchronizing transmission encoding.

12. The dual-mode audio encoding device according to claim 11, wherein the self-synchronizing transmission encoding comprises at least one of the following encodings:
Pulse Position Modulation (PPM);
Pulse Density Modulation (PDM);
Manchester encoding; and
Biphase encoding.

13. The dual-mode audio encoding device according to claim 11, wherein the first control circuit is further configured to modulate a second communication signal into a high-frequency acoustic signal, where the frequency of the high-frequency acoustic signal is higher than that of the audio frequency sound wave, and wherein the high-frequency acoustic signal is output through the acoustic diaphragm of the first speaker circuit.

14. A dual-mode audio encoding device, comprising:
an audio reception circuit, configured to receive an audio frequency sound wave and a high-frequency sound wave signal;
an electromagnetic reception circuit, configured to receive an electromagnetic signal; and
a second control circuit, coupled to the audio reception circuit and the electromagnetic reception circuit, for demodulating the received high-frequency sound wave signal to obtain a first communication signal, and for demodulating the electromagnetic signal to obtain a second communication signal.

15. The dual-mode audio encoding device according to claim 14, further comprising:
a second speaker circuit, comprising the audio reception circuit and the electromagnetic reception circuit, for receiving an audio frequency sound wave and a high-frequency sound wave signal,
wherein the electromagnetic reception circuit comprises an electromagnetic coil for driving the acoustic diaphragm of the second speaker circuit,
wherein the acoustic diaphragm of the second speaker circuit is served as the audio reception circuit.

16. The dual-mode audio encoding device according to claim 14, wherein the electromagnetic reception circuit further comprises:
a resonant coil, comprising a first terminal and a second terminal, wherein the first terminal of the resonant coil is coupled to a power supply voltage, and the second terminal of the resonant coil is coupled to the second control circuit; and
a resonant capacitor, comprising a first terminal and a second terminal, wherein the first terminal of the resonant capacitor is coupled to the second terminal of the resonant coil, and the second terminal of the resonant capacitor is coupled to a common ground voltage.

17. The dual-mode audio encoding device according to claim 16, wherein the electromagnetic reception circuit further comprises:
an envelope detection circuit, coupled between the second terminal of the resonant coil and the second control circuit.

18. The dual-mode audio encoding device according to claim 16, wherein the envelope detection circuit comprises:
a quasi-peak detector, comprising an input and an output, wherein the input of the quasi-peak detector is coupled to the second terminal of the resonant coil;
an integrator amplifier, comprising an input and an output, wherein the input of the integrator amplifier is coupled to the output of the quasi-peak detector; and
a comparator, comprising a first input, a second input, and an output, wherein the first input of the comparator is coupled to the output of the integrator amplifier, the second input of the comparator is coupled to a reference voltage, and the output of the comparator is coupled to the second control circuit.

19. A dual-mode audio encoding method, comprising:
modulating a first communication signal into an electromagnetic signal; and
using an acoustic diaphragm of a first speaker circuit to emit an ordinary audio frequency while simultaneously using the electromagnetic coil of the first speaker circuit to emit the electromagnetic signal.

20. The dual-mode audio encoding method according to claim 19, further comprising:
modulating a second communication signal into a high-frequency acoustic signal;
using the acoustic diaphragm of the first speaker circuit to emit the ordinary audio frequency while simultaneously using the acoustic diaphragm of the first speaker circuit to emit the high-frequency acoustic signal.

21. The dual-mode audio encoding method according to claim 20, further comprising:
using an audio receiver to receive the high-frequency acoustic signal; and
demodulating the received high-frequency acoustic signal to obtain the second communication signal.

22. The dual-mode audio encoding method according to claim 19, wherein the audio receiver is the acoustic diaphragm of a second speaker circuit.

23. The dual-mode audio encoding method according to claim 19, further comprising:
using a resonant coil to receive the electromagnetic signal; and
demodulating the received electromagnetic signal to obtain the first communication signal.
